(19) United States
(12) Patent Application Publication
(10) Pub. No.: US 2019/0208051 A1
(43) Pub. Date: Jul. 4, 2019

(54) CONTEXT DETECTION WITH ACCELERATED AI TRAINING AND ADAPTIVE DEVICE ENGAGEMENT

(71) Applicant: Motorola Mobility LLC, Chicago, IL (US)

(72) Inventors: Rachid Alameh, Chicago, IL (US); Jarrett Simerson, Chicago, IL (US); Zhengping JI, Chicago, IL (US)

(73) Assignee: Motorola Mobility LLC, Chicago, IL (US)

(21) Appl. No.: 15/858,461

(22) Filed: Dec. 29, 2017

(51) Int. Cl. H04M 1/725

(52) U.S. Cl. CPC H04M 1/72569; G06N 99/005; H04M 1/7253

(57) ABSTRACT

Systems and methods for enhancing the operation of a mobile communications device include detecting another device travelling to the same destination as the user's device, pairing the devices, collect context data for the user's device, and transmitting the context data to the other device. The user's device also receives context data from the other device and applies that context data to improve operation of the user's device.

### TECHNICAL FIELD

The present disclosure is related generally to mobile electronic communications devices and, more particularly, to systems and methods for device learning and adaptation through shared context.

### BACKGROUND

Although mobile communications devices such as cellular phones can sense many things about their environment, they gathered data is typically limited by the capabilities and particular environment of the device. As such, tasks such as artificial intelligence (AI) training and learning may be delayed or extended as the device samples different environments and circumstances.

Before proceeding to the remainder of this disclosure, it should be appreciated that the disclosure may address some of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to be, to accurately catalog, or to comprehensively summarize any prior art reference or practice. As such, the inventors expressly disclaim this section as admitted or assumed prior art. Moreover, the identification or implication herein of one or more desirable courses of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a general schematic representation of a mobile electronic device in which various embodiments of the disclosed principles may be implemented;

FIG. 2 is a schematic view of two mobile communications devices in communication and sharing context and training information via a Bluetooth pairing in accordance with an embodiment of the disclosed principles;

FIG. 3 is a schematic view of two mobile communications devices in communication and sharing context and training information via a cellular communications in accordance with an embodiment of the disclosed principles;

FIG. 4 is a schematic view of two mobile communications devices in accordance with an embodiment of the disclosed principles wherein one device has lost power while the other device continues to collect sharable information, and wherein sharing between devices resumes when the first devices resumes powered operation;

FIG. 5 is a schematic view of two mobile communications devices and a wearable device in communication and sharing context and training information in accordance with an embodiment of the disclosed principles; and

FIG. 6 is a process flow chart showing an example pairing, communication and data exchange process in accordance with an embodiment of the disclosed principles.

### DETAILED DESCRIPTION

Before presenting a detailed discussion of embodiments of the disclosed principles, an overview of certain embodiments is given to aid the reader in understanding the later discussion. As noted above, mobile communications devices such as cellular phones may gather data to enhancer AI learning and training, but such tasks are generally limited by the extent to which the device samples different environments and circumstances.

In an embodiment of the disclosed principles, a mobile electronic communications device uses a connection with one or more other devices to accelerate learning and to enhance decision making capabilities. In a further embodiment, device-to-device pairing, coupled with a determination that the devices are going to same destination, allows the device to work as one, forming a more powerful system, enhancing overall engagement, and propagating faster device learning and training. Whether or not the devices are going to same destination is determined based on current location or planned drives from navigation systems, road planner, meeting calendar event, scheduled common business meeting and so on.

The shared context, awareness and detections provides a better user experience by enabling better assistance with navigation, arrivals, waypoints, predictions, user state, third party engagements, etc. The sharing of data also provides an enhanced volume of data and detections, enhancing engagement with the user. Data may be shared over Bluetooth or other short range wireless link since the devices are going to the same destination together).

Moreover, devices can share intervals of context detections and environmental awareness based on location. For example, if one device is stationary, that device may defer some functions and thus does not share with the other device, conserving power. Device context and knowledge may also be shared over cellular data channels if two users are going to the same destination separately and are thus not often in Bluetooth range (e.g., less than about 100 feet).

A device may also share data with a wearable worn by the same person or others, and may train the device by sharing physical data specific to the user, e.g., wellness, sweat, motions, shaking, heart rate, sleep, food intake, mood, and so on. These wellness and physical contexts are weighted higher than similar data generated by the mobile device since the wearable is in physical contact with the user's skin. With respect to power, the two or more devices may work as one, such that when a battery on one device becomes depleted, context sensing and smart interface continue with the other device(s), and may be stored and then shared at a later time when the depleted device is up and running again.

Paired devices may monitor each other's battery, power state, context, and current tasks, to predict when another device is busy, has low power, or is facing a shutdown. Such situations, the monitoring device may take over engagement and store data for later sharing with the other device when it is again up and running. Each device may be forward looking while also maintaining current and past awareness. The system does not require manual interaction or intervention by the user.

With this overview in mind, and turning now to a more detailed discussion in conjunction with the attached figures, the techniques of the present disclosure are illustrated as being implemented in or via a suitable device environment. The following device description is based on embodiments and examples within which or via which the disclosed principles may be implemented, and should not be taken as limiting the claims with regard to alternative embodiments that are not explicitly described herein.

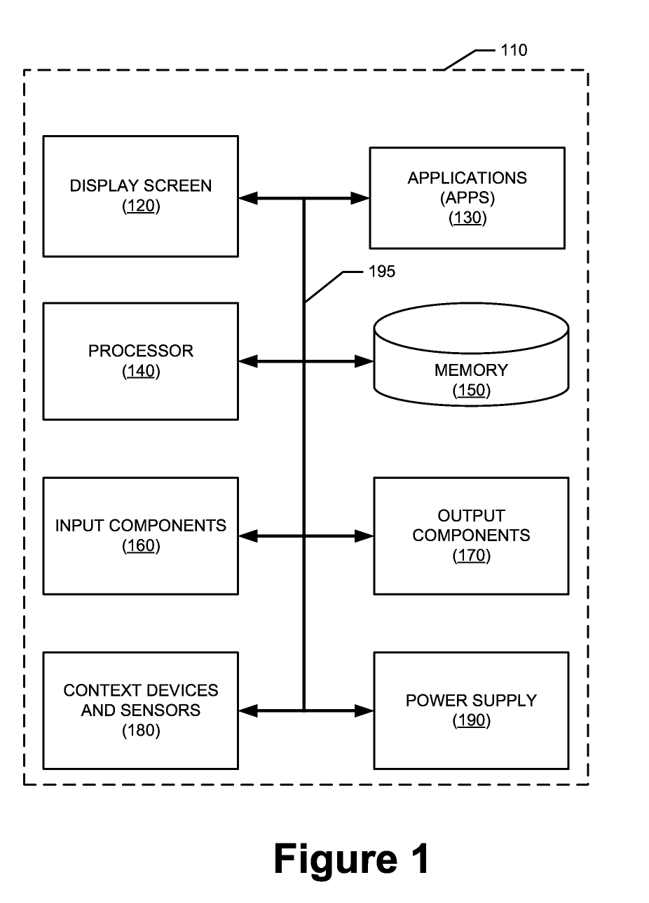

Thus, for example, while FIG. 1 illustrates an example mobile electronic communications device with respect to which embodiments of the disclosed principles may be implemented, it will be appreciated that other device types may be used, including but not limited to laptop computers, tablet computers, and so on. It will be appreciated that additional or alternative components may be used in a given implementation depending upon user preference, component availability, price point and other considerations.

In the illustrated embodiment, the components of the user device 110 include a display screen 120, applications (e.g., programs) 130, a processor 140, a memory 150, one or more input components 160 such as RF input facilities or wired input facilities, including, for example one or more antennas and associated circuitry and logic. The antennas and associated circuitry may support any number of protocols, e.g., WiFi, Bluetooth, cellular, etc.

The device 110 as illustrated also includes one or more output components 170 such as RF (radio frequency) or wired output facilities. The RF output facilities may similarly support any number of protocols, e.g., WiFi, Bluetooth, cellular, etc., and may be the same as or overlapping with the associated input facilities. It will be appreciated that a single physical input may serve for both transmission and receipt.

The processor 140 can be any of a microprocessor, microcomputer, application-specific integrated circuit, and the like. For example, the processor 140 can be implemented by one or more microprocessors or controllers from any desired family or manufacturer. Similarly, the memory 150 is a nontransitory media that may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 may include a read-only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device 110. Such functions may include, for example, interaction among various internal components and storage and retrieval of applications and data to and from the memory 150.

Further with respect to the applications and modules, these typically utilize the operating system to provide more specific functionality, such as file system service and handling of protected and unprotected data stored in the memory 150. In an embodiment, modules are software agents that include or interact with hardware components such as one or more sensors, and that manage the device 110's operations and interactions with respect to presence detection and authentication.

One or more context devices and sensors 180 provide presence detection and recognition, depth detection imagers, RGB imagers, audio detection and recognition, radio frequency (RF) detection and recognition, and other capabilities as needed to determine whether the device is at a scheduled party or a business meeting (e.g., time and place match invitation, sounds and background fit expectations, etc.), which invitees are present, what occurrences may be of interest, and so on.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

In an embodiment, a power supply 190, such as a battery or fuel cell, is included for providing power to the device 110 and its components. Additionally or alternatively, the device 110 may be externally powered, e.g., by a vehicle battery or other power source. In the illustrated example, all or some of the internal components communicate with one another by way of one or more shared or dedicated internal communication links 195, such as an internal bus.

In an embodiment, the device 110 is programmed such that the processor 140 and memory 150 interact with the other components of the device 110 to perform a variety of functions. The processor 140 may include or implement various modules and execute programs for initiating different activities such as launching an application, transferring data and toggling through various graphical user interface objects (e.g., toggling through various display icons that are linked to executable applications). As noted above, the device 110 may include one or more display screens 120. These may include one or both of an integrated display and an external display.

When multiple devices are traveling together, they communicate via Bluetooth (if close) or cellular or other wireless mode (if outside of Bluetooth range) in an embodiment. Each device detects and shares its environment, also referred to herein as “context”, with the other device for artificial intelligence (AI) training improvement. This provides distributed training and security by leveraging multiple cores distributed across different devices, modules (mods) and other hardware with similar predefined intent such as going to the same destination or conducting similar environmental tasks. Data “tagging” of devices as going to same destination may occur in advance during ad hoc pairing of devices.

Paired devices may have different functionalities, prior engagements and communications, knowledge, processing modes and power, and may also be of different types, e.g., worn, carried, etc. As noted, the identification of devices that form the system traveling to same destination occurs during ad hoc pairing.

During data sharing both ways), if the shared data are identical or similar to one another, it may be used as voting and confirmation of context by comparing each device's detection and confidence level. If the result of the data sharing and voting confirmation render a high probability of accurate detection (e.g., above a predetermined probability threshold), the training can be stopped and the goal marked as achieved.

If the shared data is complementary and supplementary, such as may occur between data sets gathered by a phone and a wearable, or by phones with different knowledge and awareness and functionality, the added knowledge is shared and input to a machine learning engine as a further data point to accelerate learning by transferring/sharing knowledge.

By way of example, consider two people, each with their own device, traveling separate paths to the same destination, e.g., going to the same restaurant, same airport, or same meeting place. Tracking of each by the other during travel is set following simple ad hoc pairing, for example.

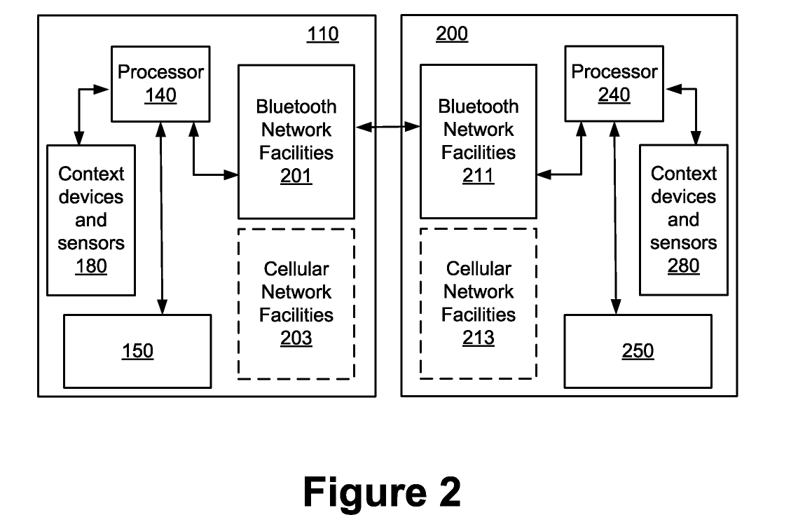

In this connection, FIG. 2 is a schematic view of two mobile communications devices in communication for sharing context and training information via a Bluetooth pairing, NFC pairing, Gesture pairing, Motion pairing, Imager pairing, Voice pairing, and so on in accordance with an embodiment of the disclosed principles. The devices 110 and 200 in the illustrated embodiment are the same or similar with respect to the primary modules in use by the devices with respect to methods described herein.

The illustrated elements include the device processor 140 (240), the device memory 150 (250), context devices and sensors 180 (280), Bluetooth networking facilities 201, 211, and cellular networking facilities 203, 213. In the context shown of FIG. 2, the devices 110, 200 are close enough to one another for short range communication protocols, and are in communication via their Bluetooth networking facilities 201, 211.

In operation, the processor 140, 240 of each device 110, 200 coordinates the information gathering of the context devices and sensors 180, 280, the storing of local or received data in the memory 150, 250, and the receipt of remote data and the transmission of locally collected data via the network facilities 201, 211, 203, 213. This is enabled by a prior setting or detection of the devices as going to same destination or conducting tasks under similar environments. With the devices 110, 200 within close range in the illustrated context, they are employing their Bluetooth networking facilities 201, 211.

In an embodiment, the devices track each other and share context with each other device at set intervals. Context can include but is not limited to device motion, device speed, phone carry mode (e.g., surface, pocket, hand, etc.), phone state (e.g., idle, call in progress, music, etc.), user voices and speech, user image, user inferred mood, nearby landmarks, public or private device setting, captured images, and other detected devices.

As noted above, the communication of context between devices may repeats at a predetermined interval, but may be initiated in part by motion and may be terminated or reduced in frequency after a predetermined time by a cessation of motion. When the devices move beyond the range of short range protocols such as Bluetooth, or if Bluetooth communication is disrupted, the devices' cellular networking facilities 203, 213 may be used to maintain communications.

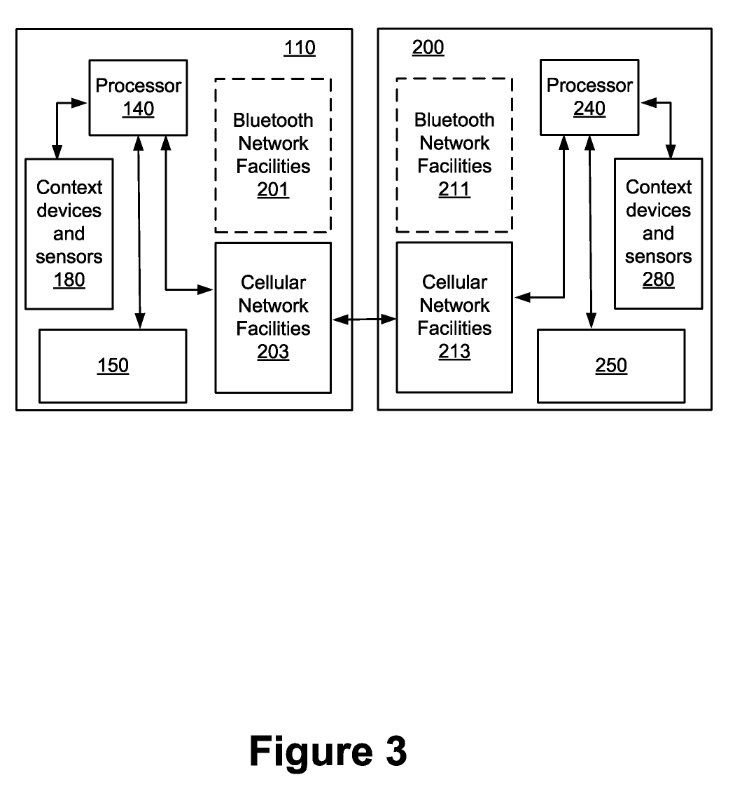

In this connection, FIG. 3 is a schematic view of two mobile communications devices in communication and sharing context and training information via a cellular communications in accordance with an embodiment of the disclosed principles. In this embodiment the processor 140, 240 of each device 110, 200 coordinates the information gathering of the context devices and sensors 180, 280, the storing of local or received data in the memory 150, 250, and the receipt of remote data and the transmission of locally collected data via the network facilities 201, 211, 203, 213.

With the devices 110, 200 within close range in the illustrated context, they are employing their cellular networking facilities 203, 213. In operation, when the device separation is expected to exceed Bluetooth range (e.g., as detected via deteriorating received signal strength indicator (via RSSI)), the other device is alerted with a GPS (global positioning satellite) stamp and communication switches to cellular.

Each device generates its context, shares with the other device, and collects the context from the other device. Devices can have different sensing capabilities, differential processing and functionality, different engagement with other devices, different knowledge of other people and faces, different phone contacts, and thus supplement each other with different data resulting in a more intelligent and aware system.

When the two devices reach the destination, and are near each other, they may work as one. For example, suppose a third person who is a contact in only a first one of the devices happens to be at the destination as well. In this situation, the one device shares the third person's name and ID to the other device via Bluetooth, cellular, or in a further embodiment, NFC (near field communication). As a result, the other device has now been trained by first device as to the third person's identity.

When the two devices reach the destination, and are near each other, they work as one. When one device shuts down due to low battery, the other device continues to determine context and then later shares its data with the previously shut down device once it is up and running again.

In an embodiment, devices share waypoints, e.g., device location at a point in time, what the device is doing at that time, the state of the user at that time, the state of the device at that time, any indication that the device is located at a key stop, landmarks nearby at that time, current and nearby roads, the time remaining to the destination, and so on). As noted above, each device may share its context with the other device at set time intervals, at predetermined key locations such as waypoints, upon restart, at landmarks or otherwise.

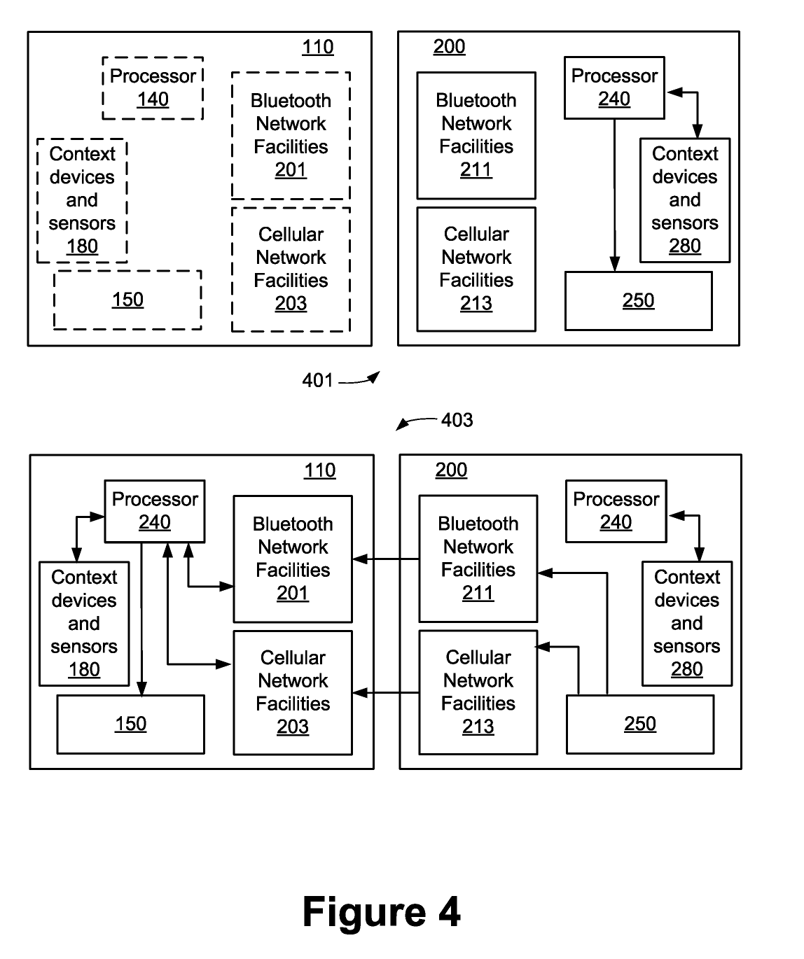

FIG. 4 is a schematic view of two mobile communications devices in accordance with an embodiment of the disclosed principles wherein one device has lost power while the other device continues to collect sharable information, and wherein sharing between devices resumes when the first devices resumes powered operation. As can be seen, in this mode, while one device is shut down as in scenario 401, the processor 240 of the still-powered device 200 coordinates the information gathering of the context devices and sensors 280 and the storing of local data in the memory 250.

When the previously unpowered device restarts as in scenario 403, the processor 240 of the still-powered device 200 coordinates the transmission of locally collected data and stored data from memory 250 via its network facilities 211, 213. Similarly, the processor 140 of the restarted device 110 coordinates the receipt and storage of the remote data via its own network facilities 201, 203 and memory 150. The particular network chosen by the sending device 200 depends upon the range between the devices at that time, e.g., using the Bluetooth networking facilities 211 at close range and the cellular networking facilities 213 at longer range.

While the foregoing examples generally focus on the situation wherein the devices 110, 200 are mobile electronic communications devices such as cellular phones, it is also contemplated that the described principles can be implemented via one or wearable devices, such as smart watches, Google glass, wearables, and the like. An example of such a wearable includes short range wireless capabilities such a Bluetooth capabilities to communicate with the same user's cellular phone, thus eliminating the need for the wearable to have cellular networking facilities. The wearable device is in contact with the user's skin in an embodiment, and therefore also has biological sensing capabilities to sense parameters such as user blood pressure, user heart rate, sweat level, sleep state, pace and so on.

In general, the more different the devices are, the more supplementary the off-device data is to each device, and the more beneficial the combination is for the user. For example, a phone and a wearable worn by the same user can give valuable supplementary data. More specifically, a device in contact with skin produces valuable wellness data that is not necessarily available from a handheld device, e.g., physical state, mood, health, falls, accidents, sleep, etc.

For at least this reason, the combination of a wearable and a handheld device allows the user to train the handheld device by sharing wearable profiles. Also, because the wearable is tied to the movement of the body (e.g., the user's wrist or arm), it can capture ergonomic data not available in the phone as well, e.g., hand motions, rotations, pressure, shaking, typing, sitting, standing, posture, agitation, etc.

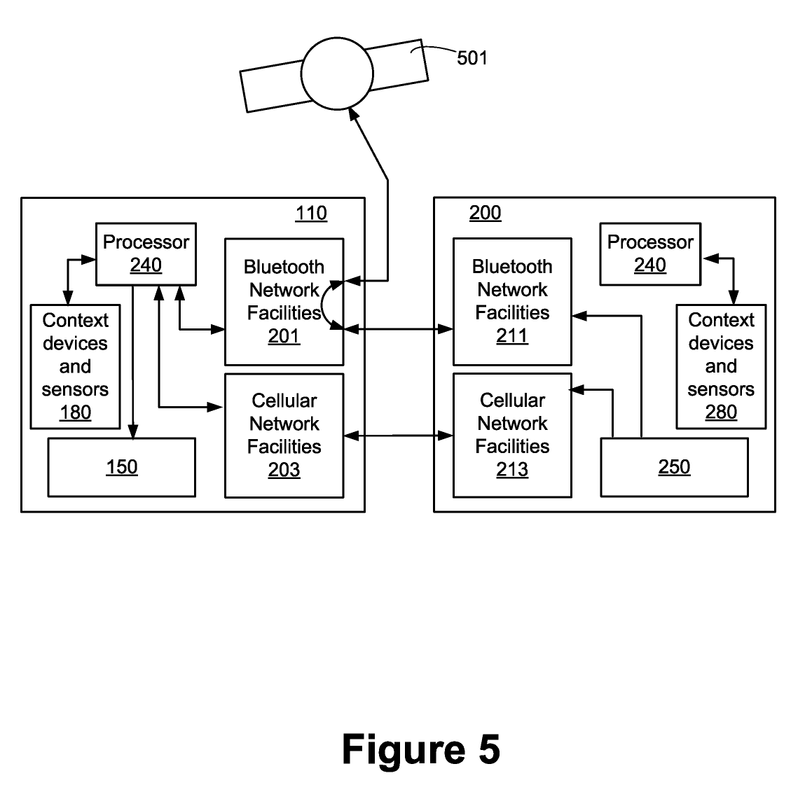

FIG. 5 is a schematic view of two mobile communications devices and a wearable device in communication, sharing context and training information in accordance with an embodiment of the disclosed principles. As can be seen, the wearable device 501 shares its data not only with the same user's cellular device 110, but also shared with the other cellular device 200 paired with the user's device 110, either indirectly (as shown) or directly, e.g., by forming a Bluetooth pairing with the other device 200.

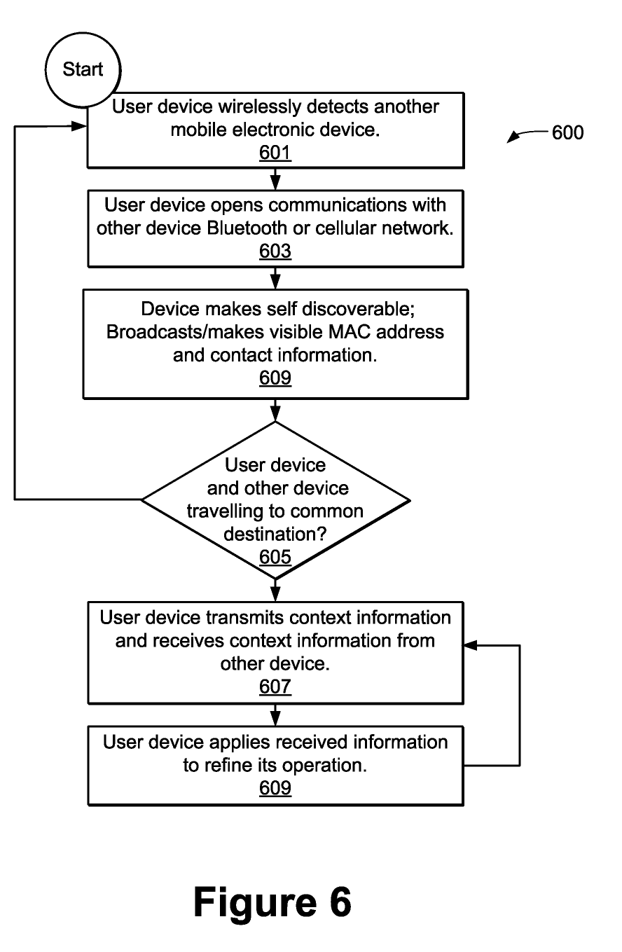

Although various processes may be used to implement the described principles, and there is no intent to limit the disclosure to any particular method for all situations, FIG. 6 is a process flow chart showing an example of pairing, communication and data exchange process in accordance with an embodiment of the disclosed principles. The environment in which the process 600 operates includes a device executing the process as well as another device with which communications may be implemented.

At stage 601 of the process 600, the user device wirelessly detects another mobile electronic device. The user device then opens communications with the device at stage 603 by Bluetooth if possible, and otherwise opens communications over a cellular network. The user device then determines at stage 605 whether the user device and the other device are travelling to a common destination, as evidenced by common meetings, reservations and so on as discussed above. In an embodiment, the act of pairing is used to determine that the user device and the other device are travelling to a common destination.

If it is determined at stage 605 that the devices are not travelling to a common destination, then the process 600 reverts to stage 601 to await detection of another device. Otherwise, the process 600 flows to stage 607, wherein the user device transmits its context information to the other device and receives context information gathered and transmitted by the other device. Finally, at stage 609, the user device applies the received information to refine its operation.

It will be appreciated that various systems and processes have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

1. A mobile communications device comprising:
a first networking system operating via a short range wireless protocol;
a second networking system operating via a long range wireless protocol;
one or more sensors configured to detect one or more respective parameters associated with the mobile communications device; and
a processor configured to detect a mobile electronic device, determine that the mobile communications device and the mobile electronic device are travelling to a common destination, pair the mobile communications device with the mobile electronic device, collect first context data from the one or more sensors, transmit the collected context data to the mobile electronic device, receive second context data from the mobile electronic device, and apply the received second context data to improve the operation of the mobile communications device.

2. The mobile communications device in accordance with claim 1, wherein the mobile communications device and the mobile electronic device are both cellular phones.

3. The mobile communications device in accordance with claim 1, wherein the mobile communications device is of a first type and the mobile electronic device is of a second type, and wherein the first type and the second type are different.

4. The mobile communications device in accordance with claim 3, wherein the mobile communications device is a cellular phone and the mobile electronic device is a wearable device.

5. The mobile communications device in accordance with claim 1, wherein the first context data comprises data associated with at least one of motion of the mobile communications device, speed of the mobile communications device, carry mode of the mobile communications device, phone state of the mobile communications device, user voice and speech, user image, user mood, nearby landmarks, and other detected devices.

6. The mobile communications device in accordance with claim 4, wherein the second context data comprises data associated with at least one of user physical state, wellness state, user mood, user health, user fall, user accident, nearby people, identities, and user sleep.

7. The mobile communications device in accordance with claim 1, wherein the short range wireless protocol comprises a Bluetooth protocol and the long range wireless protocol comprises a cellular protocol.

8. The mobile communications device in accordance with claim 1, wherein the processor is further configured to improve the operation of the mobile communications device by applying the second context data for voting and confidence enhancement.

9. The mobile communications device in accordance with claim 1, wherein the processor is further configured to detect that the mobile communications device is stationary, and in response to defer transmission of the first context data until the mobile communications device becomes nonstationary.

10. The mobile communications device in accordance with claim 1, wherein the processor is further configured to detect that the mobile electronic device has lost power, and in response to defer transmission of the first context data until the mobile electronic device regains power.

11. The mobile communications device in accordance with claim 1, wherein determining that the mobile communications device and the mobile electronic device are travelling to a common destination is based on pairing the mobile communications device with the mobile electronic device.

12. A method of enhancing operation of a mobile communications device comprising:
detecting a mobile electronic device;
determining that the mobile communications device and the mobile electronic device are travelling to a common destination;
pairing the mobile communications device with the mobile electronic device;
collecting first context data from one or more sensors associated with the mobile communications device;
transmitting the collected context data to the mobile electronic device;
receiving second context data from the mobile electronic device; and
applying the received second context data to improve the operation of the mobile communications device.

13. The method in accordance with claim 12, wherein determining that the mobile communications device and the mobile electronic device are travelling to a common destination is based on pairing the mobile communications device with the mobile electronic device.

14. The method in accordance with claim 13, wherein the second context data comprises data associated with at least one of user physical state, wellness, user mood, user health, a user fall, a user accident, and user sleep.

15. The method in accordance with claim 12, wherein the first context data comprises data associated with at least one of motion of the mobile communications device, speed of the mobile communications device, carry mode of the mobile communications device, phone state of the mobile communications device, user voice and speech, user image, user mood, nearby landmarks, and other detected devices.

16. The method in accordance with claim 12, wherein the short range wireless protocol comprises a Bluetooth protocol and the long range wireless protocol comprises a cellular protocol.

17. The method in accordance with claim 12, wherein applying the received second context data to improve the operation of the mobile communications device comprises applying the second context data for voting, confidence enhancement, or contact addition.

18. The method in accordance with claim 12, further comprising detecting that the mobile communications device is stationary, and in response, deferring or reducing transmission of the first context data until the mobile communications device becomes nonstationary.

19. The method in accordance with claim 12, further comprising detecting that the mobile electronic device has lost power, and in response deferring transmission of the first context data until the mobile electronic device regains power.

20. A mobile communications device comprising:
a first networking system operating via a Bluetooth wireless protocol;
a second networking system operating via a cellular range wireless protocol;
multiple sensors configured to detect multiple respective parameters associated with the mobile communications device; and
a processor configured to detect another mobile communications device, determine that the mobile communications device and the other mobile communications device are travelling to a common destination, pair the mobile communications device with the other mobile communications device, collect data from one or more of the multiple sensors, transmit the collected data to the other mobile communications device, receive from the other mobile communications device data indicative of an environment of the other mobile communications device, and apply the received data to improve the voting and confidence operation of the mobile communications device.
